(19) United States
(12) Patent Application Publication
(10) Pub. No.: US 2016/0142795 A1
(43) Pub. Date: May 19, 2016

(54) PORTABLE ELECTRONIC DEVICE FORMEASURING A PHYSICAL QUANTITY

(71) Applicants: Paolo MELIGA, Torino (IT); Gianfranco CIANO, Torino (IT); Elisabetta COMBA, Torino (IT)

(72) Inventors: Paolo Meliga, Torino (IT); Gianfranco Ciano, Torino (IT); Elisabetta Comba, Torino (IT)

(21) Appl. No.: 14/897,538

(22) PCT Filed: Jun. 5, 2014
(86) PCT No.: PCT/IB2014/000976

§ 371 Date: Dec. 10, 2015

(30) Foreign Application Priority Data
Jun. 11, 2013 (IT) TO2013A000478

(51) Int. Cl. H04Q 9/14; G08C 15/00; H04M 1/215

(52) U.S. Cl. CPC H04Q 9/14; H04M 1/215; G08C 15/00

(57) ABSTRACT

A portable electronic device for measuring a physical quantity has at least one sensor device that measures and converts the value or variation of a physical quantity into an analog electrical signal and an electronic device, which acquires the analog electrical signal, converts it into digital format and calculates the engineering value in real time. The device includes two distinct physical units: the first physical unit is a smart mobile electronic device, having an electrical input connecting port for a microphone jack connector, a sound card provided to receive input signals from the connecting port and send them to a processing unit, connected to the card for processing and subsequent emission and/or storage as an output by way of corresponding emission and/or storage; the second physical unit includes the at least one electrical/electronic sensor device, a jack connector corresponding to the microphone connecting port on the first unit, and an electrical/electronic component that converts the analog electrical signal into a frequency value and transmits it to the output jack connector; and wherein the first physical unit includes hardware and software that: receive the analog electrical signal, generated by the at least one sensor device, in the connecting port and convert it into a series of discrete values, the number of which in one second corresponds to the sampling frequency of the smart mobile electronic device; acquire and read the discrete sampled values, in binary data format; store the data in a buffer memory; read the buffer memory and decode the binary data into numerical data; calculate the value of the frequency of the sampled signal by way of a dedicated algorithm; convert, using dedicated software means, the calculated frequency value into a corresponding engineering value for the physical quantity measured, in real time, such that the engineering value for the physical quantity measured is emitted as an output by means of the smart mobile electronic device.

The present invention relates to a portable electronic device for measuring a physical quantity.

More specifically, the device described by the present invention is intended to provide, in real time and with an appreciable level of precision, the result of the selected measurement, with reference to one or more physical quantities.

In the current state-of-the-art, various types of portable devices are known, with dimensions that make them suitable to be carried easily by the user, and intended for the measurement of a determined physical quantity.

Preferably, these devices are suitable to be connected to a mobile telephony device by means of an audio input jack. Document no. CN102764128 A describes a device for measuring and monitoring lung functions, comprising a shell with a mouthpiece on its lower side for insufflation, while the right-hand and left-hand walls respectively, of said shall are provided with air inlets. The upper part of the shell is provided with a plug, while a rotor and a stator are arranged inside the shell, where the rotor is positioned above said mouthpiece, while the stator is positioned above the rotor. To be used, said device for measuring and monitoring lung functions is inserted, by means of the plug, into the jack input of a mobile telephony device. When the user blows into it, the blades of the rotor, which are made of a magnetic material, are caused to rotate, thereby generating a magnetic induction between said rotating blades and a coil, in which electrical signals are generated, which are transmitted to the mobile telephony device by means of said plug; at this point, said mobile telephony device receives and filters said electrical signals, analyzes the frequency spectrum and compares the data obtained with pre-set data in the same device, so that information relating to lung functions are acquired.

Another device for reading input data, which operates by connecting an external device to the jack input of a mobile telephony device, is described in the document US 8302860 B1. More specifically, said known reading device comprises a read head which in turn includes an opening making it possible to swipe a credit card or similar, and to thereby complete a requested bank transaction. Said read head reads the data contained in the magnetic strip of a credit card or similar, generating an electrical signal corresponding to said data; subsequent decoding of the data is carried out in the mobile telephony device.

Other devices are also known to the state-of-the-art, provided with more or less advanced technologies, used to monitor a person's blood alcohol level, and arranged to make use of the audio jack interface of a mobile telephony device.

However, said known devices present various types of problems. First of all, said known devices feature the presence of an on-board micro-controller for managing the digitalization and transmission of data by means of a protocol: this is an evident over-dimensioning of the hardware component, and not necessary in terms of the purpose of the device.

Additionally, most of said known devices are capable of measuring only one pre-set physical quantity, and cannot measure different, contextual or isolated quantities, according to the user's preferences.

Said known devices also have a relatively complex structure, with all that this entails in terms of difficulty of assembly, maintenance and relatively high costs.

The aim of the present invention is to provide a remedy for the above-mentioned problems. An object of the present invention is to provide a portable electronic device for measuring a physical quantity, characterized by a hardware structure that is markedly simple and adequate for carrying out the required measurements with an appreciable level of precision in the results obtained.

Another object of the present invention is to provide a device as described, which is capable of measuring one or more physical quantities, both contextually and separately, by means of the same device.

A further object of the present invention is to provide a device as indicated, which has a markedly simple structure, is of easy assembly and maintenance, and distinctly low costs. Given these objects, the present invention provides a portable electronic device for measuring a physical quantity, the essential characteristic of which forms the subject-matter of claim 1. Further advantageous characteristics of the inventions are described in the accompanying claims. The above-mentioned claims are here quoted in full.

Further characteristics and advantages of the present invention will become more apparent from the following detailed description thereof, with reference to the accompanying drawing which is given by way of a non-limiting example, wherein:

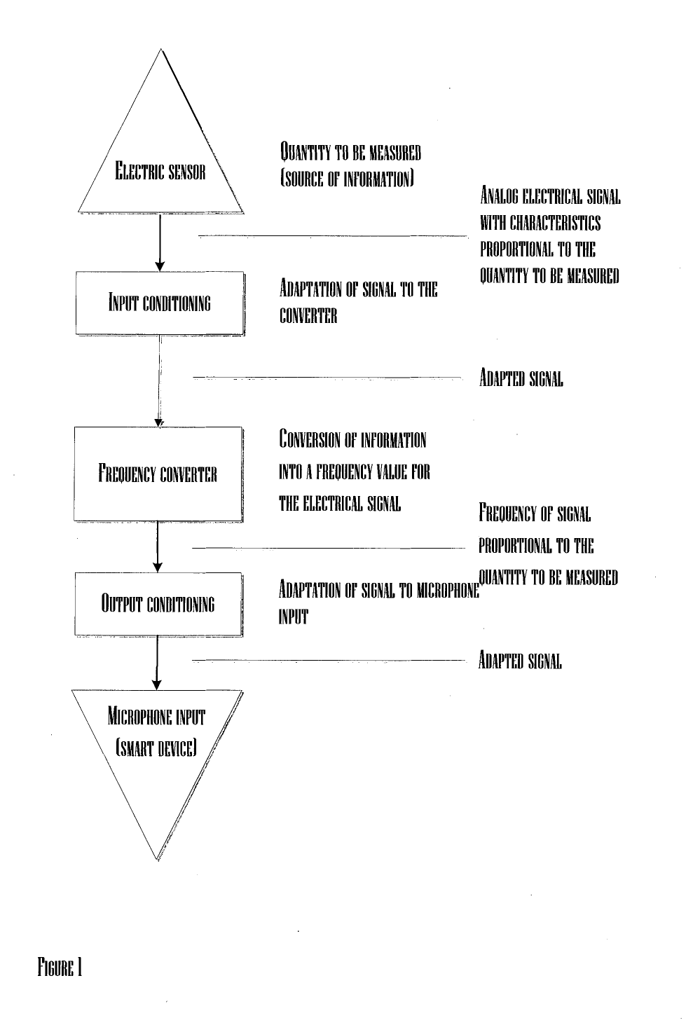

FIG. 1 is a schematic diagram of a unit of the hardware component of a portable electronic device for measuring a physical quantity according to a first embodiment of the present invention;

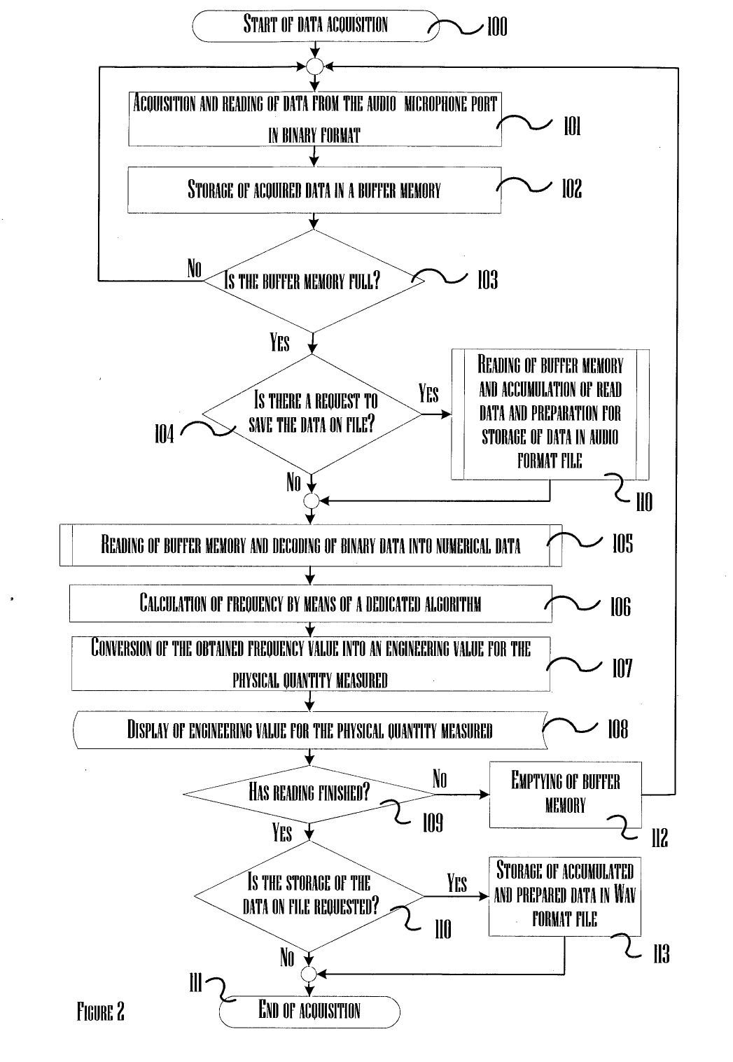

FIG. 2 is a flow diagram of the software means resident on the smart mobile electronic device, such as a smartphone for example, in relation to the operation of the device resulting from coupling with the unit shown in FIG. 1.

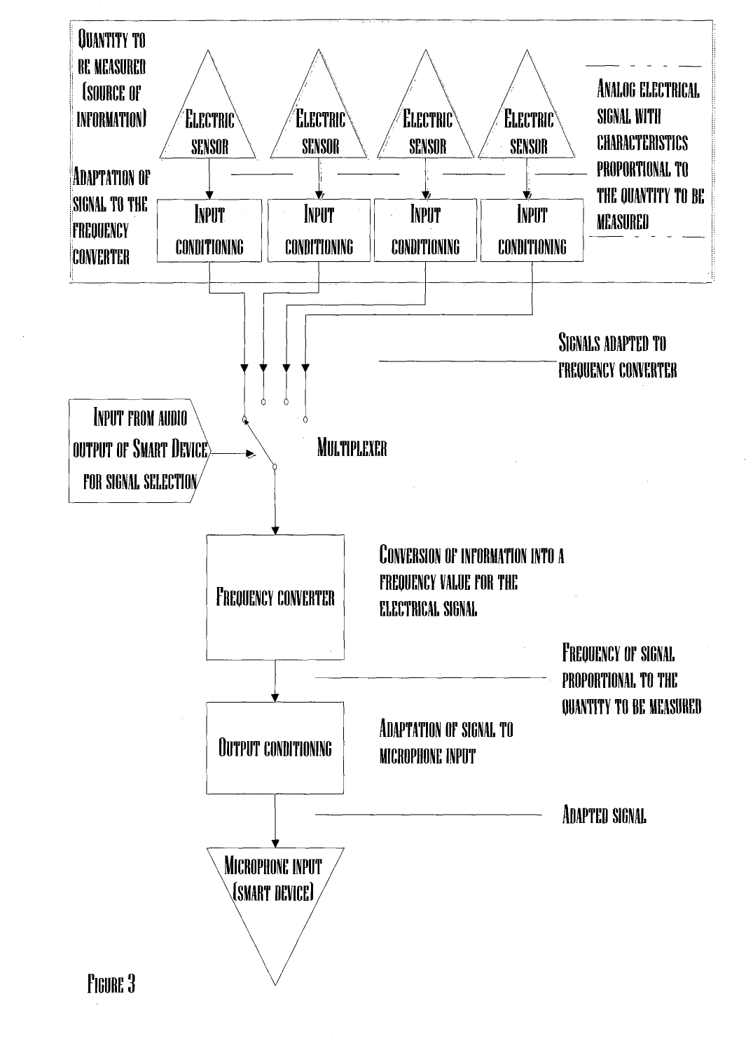

FIG. 3 is a schematic diagram of a unit of the hardware component of a portable electronic device for measuring more than one physical quantity according to a second embodiment of the present invention;

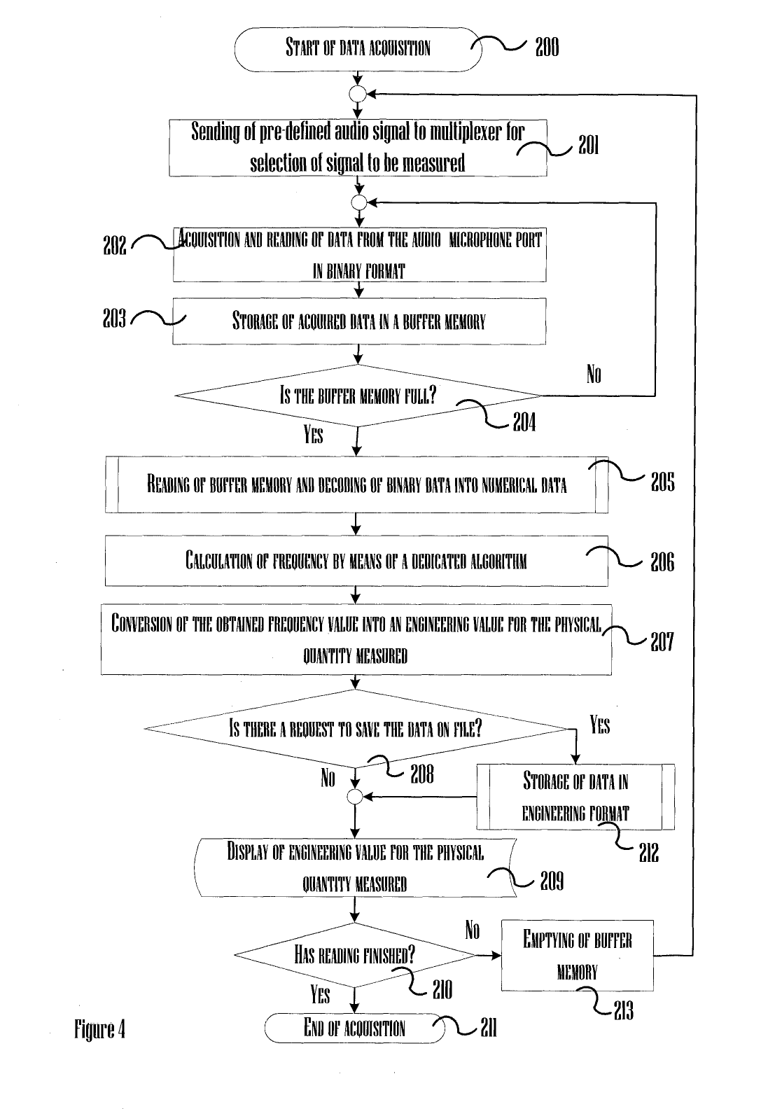

FIG. 4 is a flow diagram of the software means resident on the smart mobile electronic device, such as a smartphone for example, in relation to the operation of the device resulting from coupling with the unit shown in FIG. 3.

First embodiment of the present invention (FIGS. 1 and 2). With reference to FIG. 1, a schematic diagram of a unit of the hardware component of a portable electronic device for measuring a physical quantity according to a first embodiment of the present invention.

Said unit of the portable electronic device includes a sensor device that detects and converts a value, or variation, of a physical quantity into an analog electrical signal.

Furthermore, said device comprises a further unit constituted of an electronic device, which acquires the analog electrical signal, converts it into digital format and calculates the engineering value in real time.

Advantageously, said electronic device is a smart mobile electronic device, such as a smartphone, tablet or similar. Said mobile electronic devices are all known to the state-of-the-art and, therefore, are not described in any more detail here.

Therefore, the above-mentioned device according to the present invention comprises two distinct physical units operationally connected in a dismountable manner, of which:

the first of said physical units is said smart mobile electronic device, in turn comprising:

an electrical input connecting port for a microphone jack connector,

a sound card provided to receive input signals from said connecting port and send them to a processing unit, connected to said card for processing and subsequent emission and/or storage as an output by means of corresponding emission and/or storage means; and,

the second of said physical units comprises said electrical/electronic sensor device, a jack connector corresponding to said microphone connecting port on said first unit, and electrical/electronic means for converting said analog electrical signal, generated by said at least one sensor device, into a frequency value and transmit it to said output jack connector.

Advantageously, said first physical unit comprises hardware means and software means that:

receive said analog electrical signal, generated by said at least one sensor device, in said connecting port, and convert it into a series of discrete values, the number of which in one second corresponds to the sampling frequency of the smart mobile electronic device;

acquire and read said discrete sampled values, in binary data format;

store said data in a buffer memory;

read said buffer memory and decode said binary data into numerical data;

calculate the value of said frequency of the sampled signal by means of a dedicated algorithm;

convert, using dedicated software means, said calculated frequency value into a corresponding engineering value for the physical quantity measured, in real time.

In this manner, said engineering value for the physical quantity measured is emitted as an output by means of said smart mobile electronic device.

Given the same compatibility from the electrical point of view, the above-mentioned sensors may be integral or external with respect to said device.

Power supply to said sensors is preferably achieved independently with respect to the mobile telephony device, by means of a common battery.

Said second physical unit comprises electronic frequency converter means, which convert said analog electrical signal into a frequency value, electronic adapter means for said analog electrical signal entering said converter means, and electronic adapter means for said analog electrical signal leaving said converter means.

With reference to FIG. 2, which is a flow diagram of the software means resident on the smart mobile electronic device, such as a smartphone for example, in relation to the operation of the device resulting from coupling with the unit shown in FIG. 1.

According to the present embodiment of the invention, said software means, included in said smart mobile electronic device, perform the following steps:

Start-up 100.

Acquisition and reading of data from the audio microphone port, in binary format 101.

Storage of acquired data in a buffer memory 102.

Checking whether said buffer memory is full 103.

Checking for request to save the data on file 104.

Reading of buffer memory and decoding of binary data into numerical data 105.

Calculation of the frequency proportional to the physical quantity measured, by means of a dedicated algorithm 106.

Conversion of the obtained frequency value into a corresponding engineering value for the physical quantity measured 107.

Emission as an output of the engineering value for the physical quantity measured 108.

Checking that reading is complete 109.

Checking for request to save the data on file 110.

End 111.

Advantageously, said software means:

after checking 104 for a request to save the data on file, proceed with the subsequent phase of reading the buffer memory and accumulating read data, and of preparing for storage of the data on file 110; otherwise, they proceed directly with execution of the next step 105.

after checking that, after the phase of emission as an output of the engineering value for the physical quantity measured 108, there is a request to save the data on file 110, proceed with the subsequent phase of storing the accumulated, prepared data 113; otherwise, they proceed directly with execution of the next step 111.

after checking 103 that said buffer memory is not full, return to the previous phase of data acquisition and reading from the audio microphone port, in binary format 101; otherwise, they proceed directly with execution of the next step 104.

after checking 109 that reading is not complete, proceed with the subsequent phase of emptying the memory buffer 112, and returning to the previous phase of data acquisition and reading from the audio microphone port, in binary format 101; otherwise, they proceed directly with execution of the next step 110.

Preferably, said accumulated and prepared data are stored in an uncompressed audio format, particularly with the file extension .way. It remains understood, however, that other file extensions, provided they are compatible, fall within the scope of the present invention.

The sizing of said buffer is subject to variation depending on the specifications of the sensor, and on the speed of variation of the physical quantity.

Solely for the purpose of greater clarity, an example is given below of device operation according to the present embodiment of the invention:

Object: Measurement of the temperature of a reference environment.

Technical Specifications:

power supply for sensor and relative circuit: 2 AAA 3V batteries.

Sensor: linear response sensor; sensor operating voltage: 3V.

Procedure and Instrumentation:

Operating characteristics of linear response temperature sensor used: sensor type MCP9700 with 3V power supply: Wide Temperature Measurement Range:

−40° C. to +125° C.

Accuracy:

±4° C. (max.), 0° C. to +70° C. (MCP9700)

Wide Operating Voltage Range:

VDD=2.3V to 5.5V MCP9700/9700A

Using the sensor characteristics given on the datasheet, a formula is defined for regulating the hardware and software system

Definition of linear correspondence VOLTAGE=>TEMPERATURE, using sensor data:

Output Voltage at 0° C. TA=0° C.=>V0° C.=500 mV

Temperature Coefficient TC=10.0 mV/° C.

Sensor Transfer Function VOUT=TC×TA+V 0° C.

Calculate Inverse formula to obtain TA Ambient temperature function of VOUT

Ambient Temperature TA=VOUT/TC−V 0° C./TC

Using values TA=VOUT/10.0−500/10 mV

Definition of linear correspondence VOLTAGE=>FREQUENCY Using the information given on the datasheet, it is possible to define the hardware operating interval.

Considering the interval of the measured temperature and the 5 precision of the sensor, the starting point is set at a frequency of 250 Hz at −40° C. and with a step increase of 15 Hz per degree, we reach 2725 Hz for 125° C.

Definition of minimum: 100 mV=□ 250 Hz

Definition of maximum: 1750 mV=□ 2725 Hz.

With reference to the datasheet and the above-mentioned considerations, the following table is created:

| | Temp. ° C. | VOUT | Frequency |
|---|---|---|---|
| Minimum | TA = −40° C. | 100 mV | 250 Hz |
| | TA = 0° C. | 500 mV | 850 Hz |
| Maximum | TA = 125° C. | 1750 mV | 2725 Hz |

The Vout of the sensor should be adapted for input to the frequency converter.

Definition of linear correspondence FREQUENCY=>TEMPERATURE. Based on the instructions in the above table, the following Frequency/Temperature linear equation can be defined:

Slope=(Y2−Y1)/(X2−X1)=>(0+40)/(850−250)=0.666

### Constant=56.666

Linear Equation: TA=0.6667*Freq −56.6667

Using this information, the software can translate the frequency into a temperature value. The software will be initialized with the data thus defined in the form of a reference table and by linear interpolation.

In conclusion, the system is adapted for measuring ambient temperature.

The first conditioning block of the hardware optimizes the dynamic output of the sensor.

The second conditioning block of the hardware modifies the output signal of the frequency converter.

The signal obtained fully conforms to the microphone input characteristics.

The smart mobile electronic device will be able to read the signal obtained and convert it into digital information.

The dedicated software reads the data and shows the temperature values in degrees C.

### Second Embodiment of the Present Invention (FIGS. 3 and 4)

With reference to. FIG. 3, which is a schematic diagram of a unit of the hardware component of a portable electronic device for measuring a physical quantity according to a second embodiment of the present invention.

As evident from the above-mentioned Figure, this embodiment has a hardware component that can in part be compared to the hardware component described previously with reference to the previous embodiment, so the common parts will therefore not be described again here.

This embodiment differs from the previous one substantially for the fact that said second physical unit comprises a plurality of electrical/electronic sensor devices and a multiplexer device, which enables reading of the analog electrical signal emitted by each sensor device, according to pre-determined instructions.

Said multiplexer device carries out repeated sequential scanning of each electrical/electronic sensor device.

In a variant, said multiplexer device enables reading of a chosen one of said plurality of electrical/electronic sensor devices, based on an audio pulse signal, which is received by said electrical input connecting port on said first unit, and which pilots said multiplexer device in the selection of the connecting interface between a respective sensor device and said frequency converter means.

With reference to FIG. 4, which is a flow diagram of the software means resident on the smart mobile electronic device, such as a smartphone for example, in relation to the operation of the device resulting from coupling with the unit shown in FIG. 3.

According to this embodiment of the invention, said software means, included in said smart mobile electronic device, perform the following steps:

Start-up 200.

Sending of a pre-defined audio signal to said multiplexer device for selection of the signal to be measured 201.

Acquisition and reading of data from audio microphone port, in binary format 202.

Storage of acquired data in a buffer memory 203.

Checking whether said buffer memory is full 204.

Reading of buffer memory and decoding of binary data into numerical data 205.

Calculation of the frequency proportional to the physical quantity measured, by means of a dedicated algorithm 206.

Conversion of the obtained frequency value into a corresponding engineering value for the physical quantity measured 207.

Checking for request to save the data on file 208.

Emission as an output of the engineering value for the physical quantity measured 209.

Checking that reading is complete 210.

End 211.

Advantageously, and in a manner analogous with that described above, said software means:

after checking 204 that said buffer memory is not full, return to the previous phase of data acquisition and reading from the audio microphone port, in binary format 202; otherwise, they proceed directly with execution of the next step 205.

after checking 210 that reading is not complete, proceed with the subsequent phase of emptying the memory buffer 213, and returning to the previous phase of data acquisition and reading from the audio microphone port, in binary format 202; otherwise, they proceed directly with execution of the next step 211.

Additionally, said software means, after checking that after the conversion of the obtained frequency value into an engineering value for the physical quantity measured 207 there is a request 208 to store the data on file, proceed with the subsequent phase of storing the data in an engineering format 212; otherwise, they proceed directly with execution of the next step 209.

As is evident from the above considerations, said portable electronic device for measuring a physical quantity according to the present invention is characterized by a fully analog hardware structure where processing is transferred fully to the smart mobile unit and is therefore markedly simple and economical.

The level of measuring precision, which is already considerable, is destined to increase with technological advances in smart mobile units, since the software will automatically benefit from said characteristics, without having to undergo subsequent modifications.

Furthermore, said device as described is capable of measuring one or more physical quantities, both contextually and separately, by means of the same device.

Said device as described also has a markedly simple structure, is of easy assembly and maintenance, and distinctly low costs. It is evident from the above description that the present invention enables the objects described in the introduction to be achieved simply and advantageously.

1. A portable electronic device for measuring a physical quantity, including at least one sensor device that measures and converts the value, or variation, of a physical quantity into an analog electrical signal and an electronic device, which acquires the analog electrical signal, converts it into digital format and calculates the engineering value in real time, comprising two distinct physical units operationally connected in a dismountable manner, of which:
the first of said physical units is a smart mobile electronic device, comprising:
an electrical input connecting port for a microphone jack connector,
a sound card provided to receive input signals from said connecting port and send them to a processing unit, connected to said card for processing and subsequent emission and/or storage as an output by means of corresponding emission and/or storage;
wherein
the second of said physical units comprises said at least one electrical/electronic sensor device, a jack connector corresponding to said microphone connecting port on said first unit, and
a) an electronic adaptor that transforms the signal from the sensor or transducer into a proportional continuous voltage, regardless of the native electrical quantity provided by the sensor or transducer;
b) an electronic converter that transforms the continuous voltage into a signal of proportional frequency;
c) an electronic adaptor that renders the output from the electronic converter compatible with the micro-phone input, and transmits it to said output jack connector; and in that
said first physical unit comprises hardware and software that:
receives said analog electrical signal, generated by said at least one sensor device, in said connecting port, and converts it into a series of discrete values, the number of which in one second corresponds to the sampling frequency of the smart mobile electronic device;
acquires and reads said discrete sampled values, in binary data format;
stores said data in a buffer memory;
reads said buffer memory and decodes said binary data into numerical data;
calculates the value of said frequency of the sampled signal by way of a dedicated algorithm;
converts, using dedicated software, said calculated frequency value into a corresponding engineering value for the physical quantity measured, in real time, such that said engineering value for the physical quantity measured is emitted as an output by way of said smart mobile electronic device.

2. The device according to claim 1, wherein said second physical unit comprises a plurality of electrical/electronic sensor devices and a multiplexer device, which enables reading of the analog electrical signal emitted by each sensor device, according to pre-determined instructions.

3. The device according to claim 2, wherein said multiplexer device carries out repeated sequential scanning of each electrical/electronic sensor device.

4. The device according to claim 2, wherein said multiplexer device enables reading of a chosen one of said plurality of electrical/electronic sensor devices, based on an audio pulse signal, which is received by said electrical input connecting port on said first unit, and which pilots said multiplexer device in the selection of the connecting interface between a respective sensor device and said frequency converter.

5. The device according to claim 1, wherein said software, included in said smart mobile electronic device, performs the following steps:
Start-up;
Acquisition and reading of data from the audio microphone port, in binary format;
Storage of acquired data in a buffer memory;
Checking whether said buffer memory is full;
Checking for request to save the data on file;
Reading of buffer memory and decoding of binary data into numerical data;
Calculation of the frequency proportional to the physical quantity measured, by means of a dedicated algorithm;
Conversion of the obtained frequency value into a corresponding engineering value for the physical quantity measured;
Emission as an output of the engineering value for the physical quantity measured;
Checking that reading is complete;
Checking for request to save the data on file;
End.

6. The device according to claim 2 wherein said software, included in said smart mobile electronic device, performs the following steps:
Start-up;
Sending of a pre-defined audio signal to said multiplexer device for selection of the signal to be measured;
Acquisition and reading of data from audio microphone port, in binary format;
Storage of acquired data in a buffer memory;
Checking whether said buffer memory is full;
Reading of buffer memory and decoding of binary data into numerical data;
Calculation of the frequency proportional to the physical quantity measured, by way of a dedicated algorithm;
Conversion of the obtained frequency value into a corresponding engineering value for the physical quantity measured;
Checking for request to save the data on file;
Emission as an output of the engineering value for the physical quantity measured;
Checking that reading is complete;
End.

7. The device according to claim 5, wherein said software, after checking for a request to save the data on file, proceeds with the subsequent phase of reading the buffer memory and accumulating read data, and of preparing for storage of the data on file.

8. The device according to claim 5, wherein said software, after checking that, after the phase of emission as an output of the engineering value for the physical quantity measured, there is a request to save the data on file, proceed with the subsequent phase of storing the accumulated, prepared data.

9. The device according to claim 5, wherein said software, after checking that said buffer memory is not full, returns to the previous phase of data acquisition and reading from the audio microphone port, in binary format.

10. The device according to claim 5, wherein said software, after checking that reading is not complete, proceed with the subsequent phase of emptying the memory buffer, and returning to the previous phase of data acquisition and reading from the audio microphone port, in binary format.

11. The device according to claim 6, wherein said software, after checking that, after the conversion of the obtained frequency value into an engineering value for the physical quantity measured there is a request to store the data on file, proceeds with the subsequent phase of storing the data in an engineering format.
